(19) United States
(12) Patent Application Publication
(10) Pub. No.: US 2008/0006339 A1
(43) Pub. Date: Jan. 10, 2008

(54) INSULATING ELEMENT WITH WOUND PIPE SHELL FORMED AS A PREFABRICATED ELEMENT FOR ACCOMMODATING A HOT PIPE

(76) Inventors: Volker Albrecht, Lingenfeld (DE); Claus Bissinger, Kleinkarlbach (DE); Thomas Elfert, Leipnitz (DE); Siegbert Maas, Dietersheim (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/775,408

(22) Filed: Jul. 10, 2007

(30) Foreign Application Priority Data
Jul. 10, 2006 (DE) 20 2006 010 637.5

(51) Int. Cl. F16L 59/00

(52) U.S. Cl. 138/149

(57) ABSTRACT

The present invention concerns a thermal insulating element made from heat-resistant material, preferably mineral wool and especially rock wool, with this thermal insulating element capable of being inserted into a wall, ceiling or roof opening or the like, having at least one opening along a linear axis passing through the thermal insulating element. Its special characteristic is the fact that in the opening is arranged at least one pipe shell made from a winding-like, heat resistant fiber material, preferably mineral wool and especially rock wool for accommodating a hot pipe, with the fibers of this pipe shell having an essentially two-dimensional orientation in the circumferential direction of the shell.

### FIELD OF THE INVENTION

The invention concerns an insulating element designed as a prefabricated element as well as a system for insulation.

### BACKGROUND OF THE INVENTION

For the purpose of feeding a hot pipe through building walls, floors, roofs, panels and/or the like, break-throughs are incorporated into the brick-work or into the panel (described, without being restrictive in any way, in the following as wall or ceiling opening), or such are already provided from the beginning through which the hot pipe concerned can be fed. Hot pipes can include a connecting pipe (DIN V 18160), a flue pipe, a flue gas pipe or a chimney or chimney element, which is formed, for example, from sheet steel or refractory clay. The tradesman on location must feed the corresponding hot pipe first through the wall or ceiling opening and afterwards fill the remaining gap in order correspondingly on one hand to seal the wall or ceiling opening and on the other to immobilize the hot pipe in the very same. Mineral plugging wool is normally used for this in practice. This common, albeit laborious, practice has the disadvantage that the quality of the filling depends on the workmanship of the tradesman on location, and thus in some cases insufficient insulation properties are obtained.

For the purpose of solving this problem, insulating elements already formed as a finished unit for accommodating chimney pipes or the like have been developed. For example, German patent application P 10 2005 008 762 describes such an insulating element that may be inserted as a block-like insert into a wall or a ceiling opening and that has an essentially central opening for the feeding through of a hot pipe. This thus eliminates the addition of mineral plugging wool, such as occurs when installation is performed by a tradesman. The fact that the insulating element is furthermore formed as a prefabricated element affords fast and simple assembly because just one element is used, with the result, moreover, that consistently high insulating properties are ensured.

The generic German patent application P 10 2005 008 761 also describes one such insulating element that, however, deviates in one characteristic, namely the provision of nested core elements. The internal contours of these concentrically arranged and individually separable core elements define several different through-openings for the hot pipes, with each opening having a different cross section. Thus, such an insulating element is designed for universal installation of hot pipes of various diameters.

Although these insulating elements offer adequate fire protection (in accordance with DIN V 18160-1, or MusterFeuVO (sample firing regulation)), many users, such as manufacturers of prefabricated buildings, have lately been demanding greater insulating efficiency. Reasons for this include the recent increased tendency primarily in the private sector to use round iron stoves or chimney ovens (so-called Swedish stoves), which are growing particularly popular as additional heating systems. In some cases, wrong operation of the furnaces has led to excessively high flue gas temperatures of up to 800° C. being measured in the flue or chimney pipes of such furnaces. These excessively high temperatures (a maximum temperature of 400° C. is usually assumed) naturally burdens the surrounding wall, ceiling or panel construction, including any wall and facade cladding in the vicinity of the duct, especially if they contain flammable building materials. Particularly problematic in this connection are timber beams that are in the vicinity of the feed-through and that are part of the wall, ceiling or panel construction, especially if these are above the duct, since it is well known that heat spreads out increasingly as it rises. Even if the prescribed minimum distance of 200 mm (DIN V 18160-1: 2006.01) is observed, such timber beams can be damaged by excessively high temperatures and may even catch fire (the permanent threshold value for adjacent components in both DIN V 18160-1: 2006.01 and in the MusterFeuVO is set at 85° C., with 100° C. prescribed for a soot fire). Furthermore, a spreading, smoldering fire may occur unnoticed in the vicinity of the duct.

### SUMMARY OF THE INVENTION

Objects of the invention include increasing the insulating efficiency of such an insulating element designed as a prefabricated element and protecting the surrounding wall ceiling or panel construction against thermal exposure.

The insulating element can be provided with at least one pipe shell (or pipe jacket), which is arranged in the opening of the insulating element and whose internal contour defines a through-opening through which the pipe, preferably a flue pipe, especially a chimney pipe, can be fed. An aspect of the invention is that this pipe shell has a wound structure and essentially totally envelops the hot pipe in the feed-through region, with the term “wound” meaning that the material fibers are essentially oriented in the circumferential direction of the pipe shell (and thus the orientation is essentially two-dimensional). Due to the orientation of the material fibers, the pipe shell offers greater resistance to thermal conduction, especially in the radial direction, than if the material fibers were nondirectionally oriented.

The increased insulating efficiency of the pipe shell lessens the danger of thermal damage, especially a burn-off or scaling of the adjacent wall, ceiling or panel construction. This also applies especially when a high temperature and/or thermal exposure are only temporary (in the sense of several seconds or minutes). This advantage is seen particularly in light of the fact that hitherto insulating elements are not designed for such high temperature and/or thermal loads and that the still-common plugging wools only satisfy these requirements when properly installed.

On account of the very high thermal conduction resistance in conjunction with the body, especially in the radial direction of the pipe shell, a great deal less heat passes from the hot pipe (more precisely, from the gases and/or vapors flowing through the hot pipe) into the wall, ceiling or panel construction bordering the opening, since the radiant heat is better shielded, and, in addition, thermal conduction through the insulating element is hampered. Heat spreading is thus advantageously hampered, and the requisite surface temperatures of 85° C. or 100° C. are not exceeded. Damage to the surrounding wall, ceiling or panel construction, especially of flammable building materials, due to the excessive thermal exposure, is permanently avoided. The same also applies to any wall and/or facade cladding in the vicinity of the opening.

The pipe shell can be formed from a heat-resistant material that contains fibers, preferably made from mineral wool and especially made from rock wool.

In one embodiment, the insulating element is provided with a block-like, especially quadratic or cylindrical, body. The axis of the opening in which the at least one pipe shell is arranged passes essentially through the center of gravity of the body, for example, essentially perpendicularly to its front or rear surface. Especially for insulating elements intended for horizontal or perpendicular installation in ceilings or walls, the opening is arranged in the center of the surface, relative to a front and/or rear surface of the body (i.e., in the surface center of gravity). This is advantageous because it avoids inadvertently wrong installation. An asymmetrical arrangement would require the tradesman on location to be meticulous about correctly positioning the opening for the pipe shell, which would have to be arranged at the bottom in this case because upward heat expansion is favored, as already mentioned.

The body, like the pipe shell, can also be formed from a heat-resistant material that contains fibers, for example, from mineral wool and especially from rock wool. It is not necessary in this connection for identical materials to be used, and this is advantageous for production and logistics reasons.

In a further embodiment, which by itself constitutes an invention, the at least one pipe shell is provided with an axial length which is greater than the distance between the front and rear surface of the body. This creates a projection of the pipe shell end at the front surface and/or the rear surface. This has an advantage that those hot pipe sections which are not covered by the pipe shell are far enough away from the body and so experience a lower temperature and/or thermal exposure. A further advantage is that, as a result of this projection, it is not possible to transgress a given minimum distance from a wall and/or wall cladding (as, for example, a gypsum plasterboard). As a result, damage to the wall and/or facade cladding is critically diminished; furthermore, unpleasant discolorations due to thermal exposures in this area are prevented.

Another embodiment provides the fact that, for the purpose of incorporating the opening in the body from an external surface, a split cut is incorporated, through which the saw blade can be introduced and/or removed. In this connection, the split cut is not a straight cut, but is off-set at least once or is wave-like or the like in at least one section. The outcome of this is a labyrinthine and/or a teeth-like intermeshing of the cut surfaces. It is contemplated in this regard for the cut surfaces to be joined in a tongue-and-groove-like manner, with, naturally, several such tongue-and-groove-like connections capable of being provided per cutting line, including in directions deviating from the cut line. The purpose of such a cutting pattern is to prevent a chimney effect, which in such a split cut leads to a heat suction, especially when the split cut, from the point of view of the fed-through hot pipe, extends upwardly in an approximately vertical direction.

A further embodiment provides for the incorporation of several split cuts such that the body is detachable into several sub-parts. This can facilitate, for example, assembly and/or insertion into the wall or ceiling opening locally.

In a likewise embodiment, the insulating element has several concentrically nested pipe shells, whose internal and external jacket surfaces make essentially gap-free contact. This offers the tradesman on location the advantage of his being able to adjust the diameter (assuming that the internal contour of the pipe shell is circular, although this is not a compelling prerequisite) by removing the internal pipe shell or shells at the cross section of the local hot pipe to be installed. An advantageous outcome of this is a high measure of flexibility. Production and selling advantages also accrue, since only one insulating element has to be made available that then may be used for all conventional hot pipe cross sections.

In another embodiment, each pipe shell is formed as one piece and can have a closed circumference, as a result of which heat suction (chimney effect) into radial joints is prevented (as already described above), such that no heat bridges result from the formation of gaps in the joints.

In a further embodiment, the at least one pipe shell or the innermost pipe shell of the insulating element has a core element. Such a core element represents a kind of dummy hole for a situation in which the insulating element is inserted into the wall or ceiling opening, but a hot pipe is not fed through at that time. This creates an option to install a feed-through later, which can be accomplished readily because the preparations have been made, and no major structural measures are needed. Such a core element does not usually consist of wound material, but can nevertheless be made from mineral wool and especially from rock wool. This core element is arranged in the internal through-opening for the hot pipe such that it is removable (in the sense of detachable or separable).

A further embodiment provides for the insulating element to have at least one additional thermal or heat shield. This heat shield can be preferably in the form of at least one layer and is arranged at or incorporated into at least one side face and/or end face and/or floor face of the body. With such an additional shield, it has been shown experimentally that the permissible threshold values for adjacent parts are observed at temperatures of the fed-through hot pipe of up to 600° C.

The heat shield is can be formed from calcium silicate, gypsum and/or gypsum fiber and is bonded to the insulating element by means of water-glass. Such an insulating element can additionally have a display for the installation position, a fact which is especially advantageous if the shield is attached in one direction only. A panel-like form for the shield can be used.

Where necessary, separate protection is sought for a shield in connection with the features of an insulating element formed as a pre-fabricated part.

In another embodiment, the body and the pipe shell of the insulating element are formed from mineral fibers which are soluble in a physiological milieu and which have the following chemical composition, in weight percent:

| | | | |
|---|---|---|---|
| SiO₂ | 39-55% | preferably | 40-52% |
| Al₂O₃ | 16-27% | preferably | 16-26% |
| CaO | 9.5-20% | preferably | 10-18% |
| MgO | 1-5% | preferably | 1-4.9% |
| Na₂O | 0-15% | preferably | 2-12% |
| K₂O | 0-15% | preferably | 2-12% |
| R₂O (Na₂O + K₂O) | 10-14.7% | preferably | 10-13.5% |
| P₂O₅ | 0-3% | especially | 0-2% |
| Fe₂O₃ (total iron) | 1.5-15% | especially | 3.2-8% |
| B₂O₃ | 0-2% | preferably | 0-1% |
| TiO₂ | 0-2% | preferably | 0.4-1% |
| Other | 0-2.0% | | |

The apparent density of the body and the pipe shell can be in the range 60 to 180 kg/m3, preferably to be greater than/equal to 80 kg/m3 and especially to be 120 kg/m3. The dry binder content can also be less than 3.5%, preferably less than 2.5%.

It is furthermore contemplated that, in connection with mineral wool that is soluble in physiological milieu, the composition of the mineral fibers has a mass ratio of alkali/alkaline-earth<1 and the fiber structure of the insulating element is determined by a mean geometrical fiber diameter ≦4 μm.

In a further embodiment, at least the front or the rear surface of the body is provided with a carrier layer with an affinity for plaster and/or has a lamination for the purpose of increasing the vapor diffusion resistance (e.g., in the form of aluminum foil) which can then also serve as a connection for a vapor barrier.

The inventive insulating element can be made available as a prefabricated element.

Another aspect of the requested scope of protection shall also comprise a system for the insulation of hot pipe ducts (e.g., chimney pipe ducts, through openings or break-throughs in walls, ceilings, roofs or other masonry or panels) with an insulating element described above.

### BRIEF DESCRIPTION OF THE DRAWINGS

FIGS. 1a, 1b, 1c show a first embodiment of an inventive insulating element with a pipe shell in a front view, a side view and a perspective view.

FIGS. 2a, 2b show a second embodiment of the inventive insulating element with three concentrically arranged pipe shells in a front view and in a side view.

FIG. 3 shows an embodiment of the inventive insulating element with a shield.

FIG. 4 shows two further embodiments of the inventive insulating element with shields.

FIG. 5 shows a further embodiment of an inventive insulating element with a pipe shell in a side view.

### DETAILED DESCRIPTION OF THE PREFERRED EMBODIMENTS

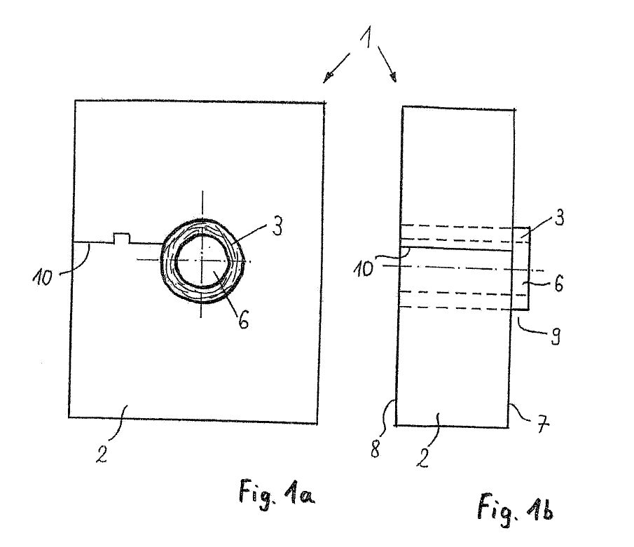

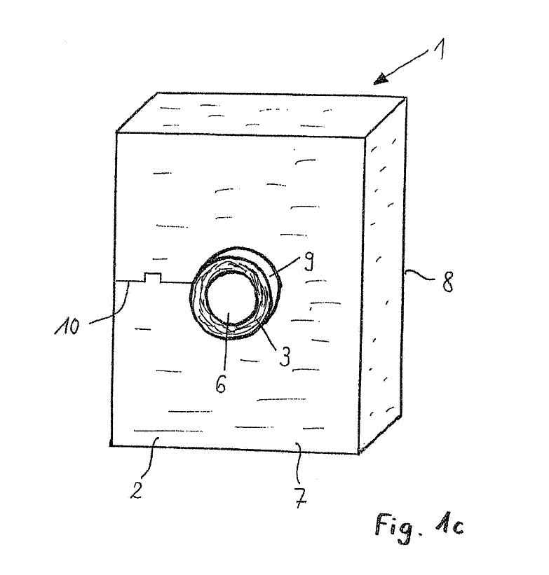

FIG. 1a is the front view of a first embodiment of an inventive insulating element, labeled overall with 1. This insulating element is provided as an essentially fully formed insert for a wall or ceiling opening or the like. The insulating element 1 comprises a block-like, more precisely quadratic body 2, and a pipe shell 3, which is arranged in a corresponding opening in the body 2. The pipe shell 3 has a circular cross section, with the cross section essentially constant along the longitudinal axis in terms of shape and size. However, it is also possible to provide a pipe shell with variable cross section dimensions such that, for example, a wedge shape is formed in the longitudinal direction. Likewise, it is possible to provide the pipe shell with other cross-sectional shapes such that non-circular hot pipes can be fed through in the cross section too. The pipe shell 3 extends through the body 2 perpendicularly from a front surface 7 to a rear surface 8, which is very clear from FIG. lb, which shows the insulating element in a side view.

Alternatively, the body can also be cylindrically shaped, especially when an inventive insulating element is used for the feed-through of hot pipes in the ceiling area.

Inside the pipe shell 3 is arranged a solid cylindrical core element 6, which closes the through-opening defined by the pipe shell 3 for the feed-through of the hot pipe. The outcome is the very advantageous option of feeding through a hot pipe at a later time, i.e., after the insulating element is already installed, and, until then, of permanently sealing and insulating the wall break-through or the like and, as necessary, of plastering it or the like.

The body 2 is formed from rock wool, although other heat-resistant insulating materials can naturally be provided too. The pipe shell 3 and the core element 6 are likewise formed from rock wool, although other heat-resistant insulating materials can be provided for this, too.

The body 2, the pipe shell 3 and the core element 6 can be made in this regard from different materials or materials of different composition.

An aspect is that the pipe shell 3 has a wound structure, with the term “wound” taken to mean that the rock wool fibers have an alignment essentially oriented in the circumferential direction of the shell. Through this winding of the rock wool, the insulating efficiency and the thermal conductivity resistance of the pipe shell increase, especially in the radial direction, as described above.

As is particularly evident from FIG. 1b, the pipe shell 3, relative to the depth or thickness of the body 2, is formed with an excess length such that a projection 9 of the front end of the pipe shell 3 occurs at the front surface 7 of the body. Likewise, it is possible to form the projection also or only at the rear surface 8. Such a projection 9 forces the tradesman on location to observe a minimum distance between a recess in the wall and/or facade cladding (such as, for example, gypsum plasterboard) and the hot pipe, as already described above. The outcome of this is that damage of adjacent components is critically reduced; furthermore unpleasant discoloration of the wall and/or facade cladding due to the thermal exposure in this area are prevented.

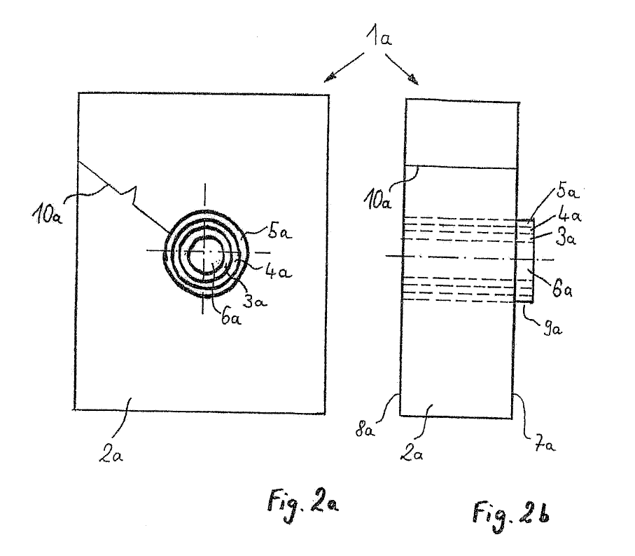

FIGS. 2a and 2b show a second embodiment of the inventive insulating element. The following description shall deal only with the essential differences from the first embodiment.

As is evident from FIG. 2a, the insulating element la comprises three pipe shells 3a, 4a which are nested inside one another in the body 2a. Of course, such an insulating element can also be made available with only two pipe shells or with more than three pipe shells. Each of these pipe shells 3a, 4a, 5a is formed from wound rock wool. The pipe shells each have a circular cross section. The insulating element la offers the advantage that the tradesman on location can adjust the diameter of the through-opening to that of the hot pipe to be fed-through, by withdrawing the internal pipe shells 3a and/or 4a. For the tradesman, the result is an advantageous high measure of flexibility.

As is evident from FIG. 2b, the pipe shells are in turn longer than the thickness of the body 2a, such that a projection 9a results at the front surface 7a. The nested pipe shells 3a, 4a and 5a are designed to have the same axial length, which is very clearly evident from FIG. 2b. Of course, it is also possible to make the individual pipe shells available with different lengths.

With both embodiments, it is possible to insert a corresponding opening for accommodating the pipe shells into the body 2, 2a. Such an opening may be effected, for example, with a saw-cut 10, 10a from one side, through which the saw blade can be introduced and also removed again. Such a split cut 10, 10a is usually not straight but made at an angle in order that the harmful chimney effect, already described above, may be avoided. In the first embodiment, therefore, this split cut 10 is, as shown in FIGS. 1a and 1c, off-set three times at 90° angles, such that the two cut surfaces engage like tongue-and-groove. In the second embodiment, the split cut is only off-set twice, as shown in FIG. 2a. These are only examples of a preferred cutting line, of course. Where, for example, a laser cutting machine or a water jet cutting machine is used, such a split cut could otherwise be dispensed with.

The pipe shell 3 of the first embodiment as well as the outermost pipe shell 5a of the second embodiment are inserted gap-free in the openings of the body 2 or 2a and are usually permanently bonded and usually thus immobile. Of course, it is also possible not to bond these. The pipe shells 3a and 4a of the second embodiment are essentially inserted gap-free and are thus radially free from play and can thus be removed by the tradesman on location. The same applies to the core elements 6 and 6a of both embodiments. In order to prevent inadvertent falling out, for example in transport or storage, the pipe shells 3a and 4a and the core elements 6 and 6a can also be slightly bonded, with this bonded joint being detachable or separable.

The insulating element can be made available in the manner previously described, i.e., with inserted pipe shell 3 and core element 6 or with inserted pipe shells 3a, 4a, 5a and core element 6a (monolithic structure), giving rise to space-saving and logistics-reducing storage and transport conditions. The pipe shells 3, 3a, 4a and 5a are also protected in this way against damage. In this finished state, the insulating element is provided, for example, with film packaging or with straps in order that this storage and transport unit may be held together and protected. Of course, it is also possible, without deviating from the inventive thought, to make the individual components available separately (kit form) such that the tradesman must assemble these on location.

The pipe shells of the first and/or the second embodiment can be formed with the internal diameters 110 mm, 130 mm, 150 mm and/or 180 mm (plus standard tolerances), since these are the standard dimensions for chimneys. Of course, different diameters are also conceivable, especially, other, i.e., non-circular feed-through cross sections (for example, rectangular or oval). The standard outer dimensions for such an insulating element in accordance with the first and the second embodiment is an approximately horizontal width of 565 mm, a vertical height of 700 mm and a depth or thickness of 200 mm, but these are not compelling preconditions. It may also be necessary to arrange several such insulating elements one behind the other in order to fill out a deeper wall or ceiling opening. The projection of the pipe shell ends over the end faces (front or rear surface) of the body is estimated at 25 mm (corresponding to two-layered paneling with gypsum plasterboards of 12.5 mm standard thickness), such that the corresponding pipe shells must be made available with 25 mm excess length, or with 50 mm excess length if a double-sided projection is desired. These, too, are naturally not compelling preconditions.

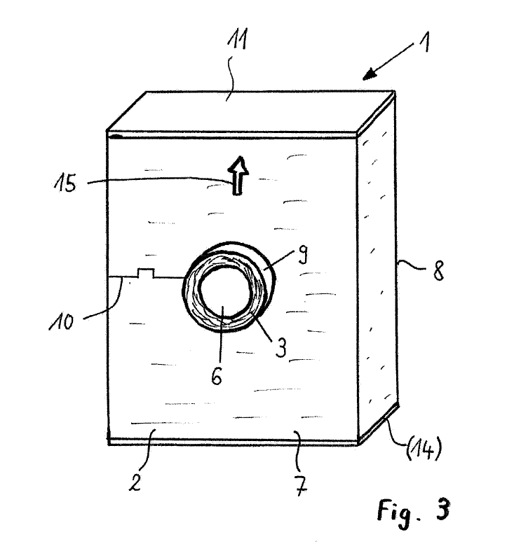

FIG. 3 shows an inventive insulating element 1 in accordance with the illustration and description of FIGS. 1a to 1c. This insulating element 1 has a shield labeled 11 at its upper side face (end face). This layer-like or also panel-like shield 11 is made from a temperature-stable or heat-stable material, such as calcium silicate, gypsum and/or gypsum fiber. The shield 11 has already been connected or bonded by means of water-glass to the body 2 of the insulating element 1 by the manufacturer and covers the entire width and depth of the body (2), although this need not be the case. As a result of the shield 11, even better thermal protection is obtained upwardly (expressed in terms of the installation position) for the upwardly adjacent building parts. In order to give the tradesman on location the correct installation position, insulating element 1 additionally bears a display showing the correct installation position 15, which is realized here, for example, by an arrow. For the purpose of avoiding installation errors, the inventive insulating element 1 may also have at the lower end face a further shield 14, which also is formed in the shape of a layer or panel. It goes without saying that the shield 11 described above may also be combined with the embodiment in accordance with FIGS. 2a and 2b.

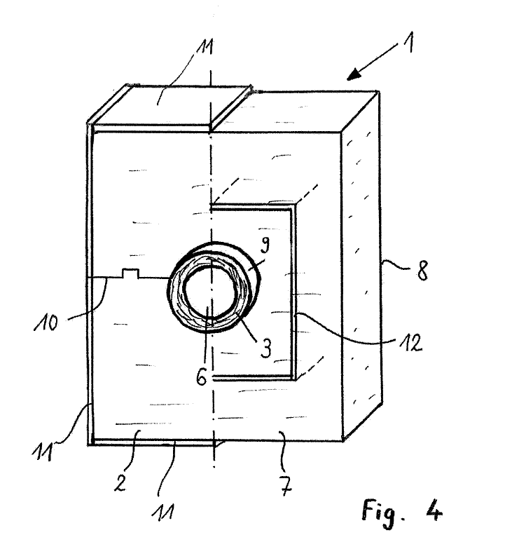

FIG. 4 shows two further embodiments of one such shield. In the left of FIG. 4 is illustrated a shield whose layers completely surround the side faces of the insulating element 1 and also have been already connected to it (e.g. bonded) permanently by the manufacturer. The shield 11 surrounds the side faces here (including end and floor face) like a box, as it were. The right of FIG. 4 shows the shield already incorporated into the body 2 (e.g. clamped or bonded) by the manufacturer. As illustrated, this internal shield forms an internal frame 12, which is incorporated into the body 2 and is surrounded internally and externally by the material of the body 2. Relative to the previously described embodiments with shielding, this variant offers the advantage of continued simple adaptability, since the tradesman on location can simply and easily cut the material of the body 2 that is outside the internal shield 12 to the corresponding dimensions of the wall or ceiling opening. Naturally, the previously described embodiments may also be combined with the embodiment in accordance with FIGS. 2a and 2b. The internal shield 12 could also be conceivably arranged only above and/or below (expressed in terms of the installation position) the pipe shell 3 in the body 2.

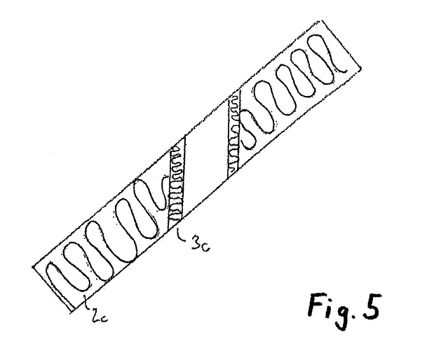

FIG. 5 shows an inventive insulating element for the feed-through of a double-walled high-grade steel chimney pipe through a sloping roof. The opening is implemented in the inclined angle to the front or rear surface of the insulating element corresponding to the pitch of the roof, such that the high-grade steel chimney is fed perpendicularly through the roof, with the axis of the opening going through the body's center of gravity. The opening of the body 2c has a wound pipe shell 3c, which serves to accommodate the high-grade steel chimney.

All characteristics of the embodiments described above are to be understood as general characteristics of the invention and therefore especially also combinable with one another.

We claim:

1. A thermal insulating element capable of being inserted into a wall, ceiling or roof opening or the like comprising:
a heat-resistant material having at least one opening along a linear axis passing therethrough;
at least one pipe shell made from a winding-like, heat resistant fiber material arranged in the at least one opening, with fibers of the at least one pipe shell having a two-dimensional orientation in a circumferential direction of the shell.

2. The thermal insulating element in accordance with claim 1, wherein:
the thermal insulating element has a block-like quadratic or cylindrical body.

3. The thermal insulating element in accordance with claim 2, wherein:
an axis of the opening of the body passes through a center of gravity of the body.

4. The thermal insulating element in accordance with claim 2, wherein:
at least one pipe shell has an axial length that is greater than a distance between a front and rear surface of the body, such that an axial projection of an end of at least one pipe shell is formed at at least one of these two surfaces.

5. The thermal insulating element in accordance with claim 2, wherein:
the body has at least one split cut from an external surface to the opening.

6. The thermal insulating element in accordance with claim 5, wherein:
at least sections of the at least one split cut are corrugated or off-set once, such that a corrugated, labyrinthine and/or teeth-like intermeshing of the cut surfaces occurs.

7. The thermal insulating element in accordance with claim 1, wherein:
at least one pipe shell is monolithic.

8. The thermal insulating element in accordance with claim 2, wherein:
the pipe shell arranged directly in the opening of the body is arranged gap-free.

9. The thermal insulating element in accordance with claim 1, further including:
a hot pipe having an inner through-opening in the at least one pipe shell, wherein a removable core element made from heat-resistant material is arranged in the inner through-opening for the hot pipe, with the core element being arranged gap-free in the through-opening.

10. The thermal insulating element in accordance with claim 1, wherein:
several pipe shells are nested gap-free inside each other for adjustment to a respective cross-sectional shape and/or size of the hot pipe to be fed through, with these pipe shells being arranged such that they are detachable from each other.

11. The thermal insulating element in accordance with claim 1, wherein:
the thermal insulating element has exactly one pipe shell.

12. The thermal insulating element in accordance with claim 1, wherein:
the at least one pipe shell is formed with a circular cross section and an internal diameter of 110 mm, 130 mm, 150 mm and/or 180 mm.

13. The thermal insulating element in accordance with claim 1, wherein;
the insulating element has at least one additional heat shield.

14. The thermal insulating element in accordance with claim 2, wherein:
the at least one additional heat shield is mounted to or incorporated into at least one side face of the body in the form of at least one layer.

15. The thermal insulating element in accordance with claim 13, wherein:
the at least one additional heat shield is formed from calcium silicate, gypsum and/or gypsum fiber.

16. The thermal insulating element in accordance with claim 13, further including:
a display showing an installation position.

17. The thermal insulating element in accordance with claim 2, wherein:
the body and the at least one pipe shell are formed from mineral fibers which are soluble in a physiological milieu and which have the following chemical composition, in weight percent:

| | |
|---|---|
| SiO₂ | 39-55% |
| Al₂O₃ | 16-27% |
| CaO | 9.5-20% |
| MgO | 1-5% |
| Na₂O | 0-15% |
| K₂O | 0-15% |
| R₂O (Na₂O + K₂O) | 10-14.7% |
| P₂O₅ | 0-3% |
| Fe₂O₃ (total iron) | 1.5-15% |
| B₂O₃ | 0-2% |
| TiO₂ | 0-2% |
| Other | 0-2.0% |

18. The thermal insulating element in accordance with claim 2, wherein:
an apparent density of the body and the at least one pipe shell is in the range 60 to 180 kg/m3.

19. The thermal insulating element in accordance with claim 2, wherein:
a dry binder content of the body and the at least one pipe shell is less than 3.5%.

20. The thermal insulating element in accordance with claim 2, wherein:
at least a front or a rear surface of the body is provided with a carrier layer with an affinity for plaster.

21. The thermal insulating element in accordance with claim 2, wherein:
at least a front or a rear surface of the body has a lamination.

22. The thermal insulating element in accordance with claim 1, wherein:
the thermal insulating element is made available as a prefabricated part.

23. A system for the insulation of hot pipe ducts, with the thermal insulating element in accordance with claim 1.

24. The thermal insulating element in accordance with claim 1, wherein:
the winding-like, heat resistant fiber material is mineral wool.

25. The thermal insulating element in accordance with claim 24, wherein:
the winding-like, heat resistant fiber material is rock wool.

26. The thermal insulating element in accordance with claim 3, wherein:
the axis passes through the center of gravity of the body perpendicularly to its front or rear surface.

27. The thermal insulating element in accordance with claim 5, wherein:
the at least one split cut is not straight.

28. The thermal insulating element in accordance with claim 6, wherein:
the cut surfaces are joined by a tongue-and-groove joint.

29. The thermal insulating element in accordance with claim 7, wherein:
the at least one pipe piece is formed closed around its circumference.

30. The thermal insulating element in accordance with claim 8, wherein:
the pipe shell is arranged directly in the opening of the body and is immobile in the opening.

31. The thermal insulating element in accordance with claim 8, wherein:
the removable core element is made from mineral wool.

32. The thermal insulating element in accordance with claim 31, wherein:
the removable core element is rock wool.

33. The thermal insulating element in accordance with claim 17, wherein:
the body and the at least one pipe shell are formed from mineral fibers which are soluble in a physiological milieu and which have the following chemical composition, in weight percent:

| | |
|---|---|
| SiO₂ | 40-52% |
| Al₂O₃ | 16-26% |
| CaO | 10-18% |
| MgO | 1-4.9% |
| Na₂O | 2-12% |
| K₂O | 2-12% |
| R₂O (Na₂O + K₂O) | 10-13.5% |
| P₂O₅ | 0-2% |
| Fe₂O₃ (total iron) | 3.2-8% |
| B₂O₃ | 0-1% |
| TiO₂ | 0.4-1% |
| Other | 0-2.0% |

34. The thermal insulating element in accordance with claim 18, wherein:
the apparent density of the body and the at least one pipe shell is in the range 80 to 180 kg/m3.

35. The thermal insulating element in accordance with claim 34, wherein:
the apparent density of the body and the at least one pipe shell is 120 kg/m3.

36. The thermal insulating element in accordance with claim 19, wherein:
the dry binder content of the body and the at least one pipe shell is less than 2.5%.

37. The thermal insulating element in accordance with claim 21, wherein:
the lamination is in the form of an aluminum foil.
